(19) United States
(12) Patent Application Publication
(10) Pub. No.: US 2026/0298706 A1
(43) Pub. Date: Oct. 1, 2026

(54) LIGHT DETECTION ELEMENT

(71) Applicant: TDK Corporation, Tokyo (JP)

(72) Inventor: Yusho HIRATA, Tokyo (JP)

(73) Assignee: TDK Corporation, Tokyo (JP)

(21) Appl. No.: 19/578,978

(22) Filed: Mar. 26, 2026

(30) Foreign Application Priority Data
Mar. 28, 2025 (JP) 2025-056047

(51) Int. Cl. G01J 1/44

(52) U.S. Cl. CPC G01J 1/44

(57) ABSTRACT

A light detection element includes: a magnetic element 10 as a light detection portion for detecting light; a first electrode 11 having optical transparency; and a second electrode 12. The magnetic element 10 is, for example, a magnetoresistance effect element such as an MTJ pillar. The magnetic element 10 is located between the first electrode 11 and the second electrode 12. The light detection portion has a rectangular shape with different lengths of long side and short side when viewed in a plan view from a first direction, which is a direction of incidence of the light. The light detection element can provide polarization selectivity and/or wavelength selectivity.

### CROSS-REFERENCE TO RELATED APPLICATION

This application claims a priority, under the Paris Convention, to Japanese Patent Application No. 2025-056047 filed on Mar. 28, 2025, the entirety of which is incorporated herein by reference.

### TECHNICAL FIELD

The present disclosure relates to a light detection element.

### BACKGROUND

As recognized by the present inventor, photoelectric conversion elements such as light detection elements are used in various applications. Japanese Patent Application Publication No. 2001-292107 discloses a receiver that receives optical signals using a photodiode. The photodiode is, for example, a pn junction diode using a semiconductor pn junction, and converts light into an electrical signal.

Light detection elements such as spin photodetectors have response sensitivity in the ultraviolet to near-infrared wavelength range. When such a light detection element is used as a light receiving element in optical communications, for example, even if it is desired to be detected only light within a specific wavelength and/or polarization, there is a concern that signals of other wavelengths and polarizations may be mixed in as noise.

FIG. 11 shows, as an example, the relationship between the input signal and the output signal when a conventional light detection element is used in a receiving device for optical communications using a multiplexing method. In this example, a signal with wavelength λ1 and a signal with wavelength λ2 are multiplexed by a multiplexer 21 and sent to an optical fiber 25. The multiplexed signal sent through the optical fiber 25 is demultiplexed by a demultiplexer 22 into a signal with wavelength λ1 and a signal with wavelength λ2, which are detected by spin photodetectors 23 and 24, respectively. However, if crosstalk occurs in the optical signal in the demultiplexer 22, the two signals will mix together, causing distortion in the output signal.

In view of the above circumstances, there is a demand for a light detection element that can selectively detect a specific wavelength and/or polarization. One of the aspects of this disclosure provides a light detection element that has polarization selectivity and/or wavelength selectivity.

### SUMMARY

One aspect of the present disclosure provides a light detection element including: a light detection portion for detecting light; a first electrode having optical transparency; and a second electrode; wherein: the light detection portion is located between the first electrode and the second electrode; and the light detection portion has a rectangular shape with different lengths of long side and short side when viewed in a plan view from a first direction, which is a direction of incidence of the light.

### BRIEF DESCRIPTION OF DRAWINGS

FIG. 1 shows a plan view showing the configuration of a light detection element according to an embodiment of the present disclosure.

FIG. 2 shows a cross-sectional view taken along line II-II in FIG. 1.

FIG. 3 shows a partially enlarged cross-sectional view showing the configuration of the magnetic element shown in FIG. 2.

FIG. 4 shows a diagram showing the results of a simulation of the amount of light absorption by an MTJ pillar when irradiated with X-polarized light.

FIG. 5A shows a graph plotting the center lines of the absorption bands in the simulation results of FIG. 4.

FIG. 5B shows a graph plotting the boundary lines of the absorption bands the simulation results of FIG. 4.

FIG. 6A shows a table showing the real coefficients a and b for the thickness Lz of each magnetic element when the center lines of the absorption bands are expressed as a quadratic function.

FIG. 6B shows a table showing the real coefficients a, b, c, and d for the thickness Lz of each magnetic element when the absorption bands are expressed as a quadratic inequality.

FIG. 7A shows a diagram showing the results of a simulation of the amount of light absorption by the MTJ pillar, where Lz=20 nm.

FIG. 7B shows a diagram showing the results of a simulation of the amount of light absorption by the MTJ pillar, where Lz=49 nm.

FIG. 8A shows a diagram showing the results of a simulation of the amount of light absorption by the MTJ pillar, where Lz=78 nm.

FIG. 8B shows a diagram showing the results of a simulation of the amount of light absorption by the MTJ pillar, where Lz=107 nm.

FIG. 9A shows a diagram showing the results of a simulation of the amount of light absorption by the MTJ pillar, where Lz=136 nm.

FIG. 9B shows a diagram showing the results of a simulation of the amount of light absorption by the MTJ pillar, where Lz=165 nm.

FIG. 10 shows a diagram showing the relationship between the input signal and the output signal when a light detection element according to an embodiment of the present disclosure is used in a receiver for optical communications using a multiplexing method.

FIG. 11 shows a diagram showing the relationship between the input signal and the output signal when a conventional light detection element is used in a receiver for optical communications using a multiplexing method.

### DETAILED DESCRIPTION

Hereinafter, an embodiment of the present disclosure will be described in detail with reference to the drawings.

In order to facilitate understanding, the scale of each part in the drawings may differ from the actual scale. In the xyz cartesian coordinate system set in the drawings, the x-axis direction and the y-axis direction may be horizontal, and the z-axis direction may be vertical. The positive direction of the z-axis may also be called the upward direction, and the negative direction of the z-axis may also be called the downward direction, but this has nothing to do with the direction of gravity. In directions such as parallel, right angle, orthogonal, horizontal, vertical, up and down, left and right, a deviation that does not impair the effect of the embodiment is allowed. In addition, “~” which indicates a numerical range means that the numerical values written before and after “~” are included as the lower and upper limits. A and/or B means A and B, or A or B.

[Embodiment] An embodiment of the present disclosure will be described.

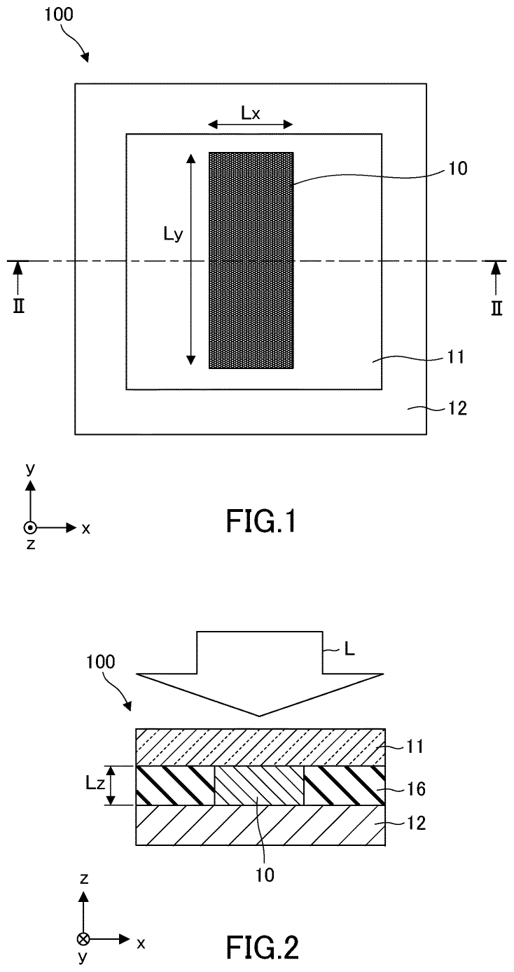

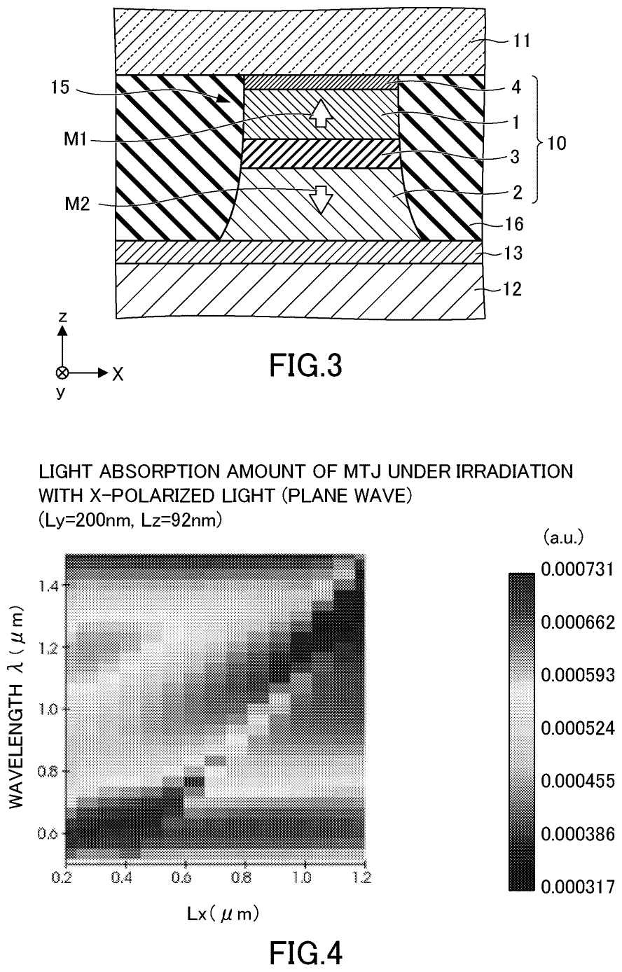

(Configuration) FIG. 1 is a plan view showing the configuration of a light detection element 100 according to an embodiment of the present disclosure, and FIG. 2 is a cross-sectional view taken along line II-II in FIG. 1. As shown in FIGS. 1 and 2, the light detection element 100 includes a light detection portion 10 for detecting light, a first electrode 11 that is light-transmitting or transparent, and a second electrode 12. The light detection portion 10 is located between the first electrode 11 and the second electrode 12. When viewed from a first direction (i.e., the z-axis direction) in which light is incident, the light detection portion 10 has a rectangular shape with different lengths of long and short sides. The light detection element 100 is, for example, a spin photodetector, and may have a columnar shape, such as a rectangular column or a cylindrical shape. In this embodiment, the light detection portion 10 is a magnetic element such as an MTJ element, as will be described later, and in the following description, the “light detection portion” may also be referred to as a magnetic element.

Light L incident on the light detection element 100 passes through the first electrode 11 that is light-transmitting and is irradiated onto the magnetic element 10, which is the light detection portion. The magnetic element 10 detects the irradiated light and converts it into an electrical signal. This electrical signal is extracted using the first electrode 11 and the second electrode 12 provided above and below the magnetic element 10.

The “light” described in this specification is not limited to visible light, but may be infrared light, which has a longer wavelength than the visible light, or ultraviolet light, which has a shorter wavelength than the visible light. The wavelength of the visible light is, for example, 380 nm or more and less than 800 nm. The wavelength of infrared light is, for example, 800 nm or more and less than 1 mm. The wavelength of the ultraviolet light is, for example, 200 nm or more and less than 380 nm.

Each component will be described hereinafter.

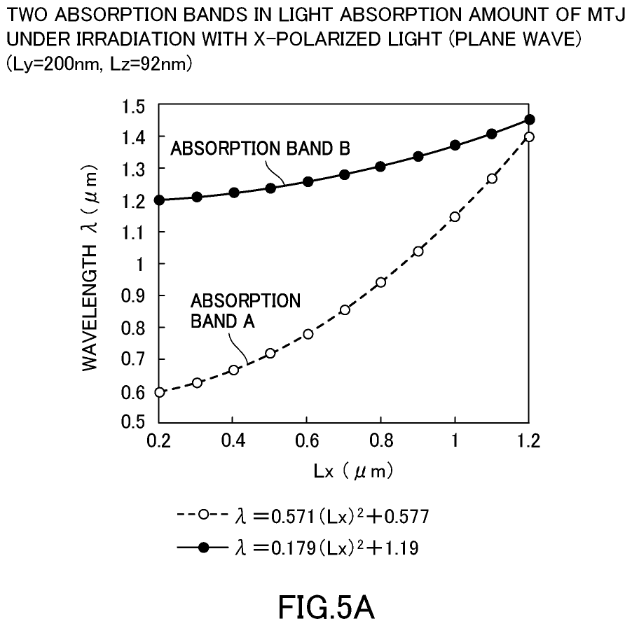

(Magnetic Element) FIG. 3 is a partially enlarged cross-sectional view showing the configuration of the magnetic element 10 of FIG. 1. As shown in FIG. 3, the magnetic element 10 includes at least a first ferromagnetic layer 1, a second ferromagnetic layer 2, and a spacer layer 3 sandwiched between the first ferromagnetic layer 1 and the second ferromagnetic layer 2. In FIG. 3, the second ferromagnetic layer 2, the spacer layer 3, the first ferromagnetic layer 1, and the cap layer 4 are stacked in this order in the positive direction of the z-axis to form a stacked body 15. The stacked body 15 constituting the magnetic element 10 may further include other layers such as a third ferromagnetic layer, a buffer layer, a seed layer, a magnetic coupling layer, and a perpendicular magnetization induction layer as necessary.

As shown in FIG. 3, a first electrode 11 is formed on the upper side of the stacked body 15, and a second electrode 12 is formed on the lower side of the stacked body 15 via a cap layer 13. The magnetic element 10 thus referred to as may include the first electrode 11, the second electrode 12, the cap layer 13, the insulating layer 16, etc. in addition to the stacked body 15. The cap layer 4 is located between the first ferromagnetic layer 1 and the first electrode 11, and the cap layer 13 is located between the second ferromagnetic layer 2 and the second electrode 12. The insulating layer 16 is formed between the first electrode 11 and the cap layer 13 or the second electrode 12, and is provided so as to cover the periphery of the stacked body 15.

The magnetic element 10 is, for example, an MTJ element in which the spacer layer 3 is made of an insulating material. In this case, the magnetic element 10 can exhibit a tunnel magnetoresistance (TMR) effect. The resistance value of the magnetic element 10 changes when it is irradiated with light from the outside. In the magnetic element 10, the resistance value in the z-axis direction (resistance value when a current flows in the z-axis direction) changes according to the relative change between the state of the magnetization M1 of the first ferromagnetic layer 1 and the state of the magnetization M2 of the second ferromagnetic layer 2. For example, the resistance value in the z-axis direction of the magnetic element 10 changes according to the change in the relative angle between the direction of the magnetization M1 of the first ferromagnetic layer 1 and the direction of the magnetization M2 of the second ferromagnetic layer 2. In addition, for example, the resistance value in the z-axis direction of the magnetic element 10 changes according to the change in the magnitude of the magnetization M1 of the first ferromagnetic layer 1.

In addition, for example, when the spacer layer 3 is made of metal, the magnetic element 10 can exhibit a giant magnetoresistance (GMR) effect. Such an element is called a GMR element. Even when the magnetic element 10 is a GMR element, the resistance value in the z-axis direction (resistance value when a current flows in the z-axis direction) changes according to the relative change between the state of magnetization M1 of the first ferromagnetic layer 1 and the state of magnetization M2 of the second ferromagnetic layer 2. The magnetic element 10 may be called an MTJ element, a GMR element, etc., depending on the material of the spacer layer 3, but is also collectively called a magnetoresistance effect element. The total thickness of the magnetic element 10 is, for example, 20 nm~165 nm.

The magnetic element 10 may have a ferromagnetic material whose magnetization state changes when irradiated with light, and the resistance value may change with the change in the magnetization state. The magnetic element 10 may be, for example, the above-mentioned MTJ element and GMR element, as well as an anisotropic magnetoresistance (AMR) effect element, a colossal magnetoresistance (CMR) effect element, etc.

The magnetic element 10 may be used together with a lens and placed at the focal position of the light in the band of use focused by the lens. It is preferable that the focal position of the light in the band of use overlaps, for example, with the first ferromagnetic layer 1. For example, when the visible light is used, the magnetic element 10 is placed at the focal position of light in a specific wavelength range of 380 nm or more and less than 800 nm. Also, for example, when the infrared light is used, the magnetic element 10 is placed at the focal position of light in a specific wavelength range of 800 nm or more and 1 mm or less. Also, for example, when the ultraviolet light is used, the magnetic element 10 is placed at the focal position of light in a specific wavelength range of 200 nm or more and less than 380 nm.

<First ferromagnetic layer> The first ferromagnetic layer 1 is a light detection layer whose magnetization state changes when light is irradiated from the outside. The first ferromagnetic layer 1 is also called a magnetization free layer. The magnetization free layer is a layer containing a magnetic material whose magnetization state changes when a specific external energy is applied thereto. The specific external energy is, for example, light irradiated from the outside, a current flowing in the z-axis direction of the magnetic element 10, an external magnetic field, etc. The magnetization M1 of the first ferromagnetic layer 1 changes state depending on the intensity of the irradiated light.

The first ferromagnetic layer 1 contains a ferromagnetic material. The first ferromagnetic layer 1 contains at least one of magnetic elements such as Co, Fe, or Ni. The first ferromagnetic layer 1 may contain elements such as B, Mg, Hf, and Gd in addition to the magnetic elements described above. The first ferromagnetic layer 1 may be, for example, an alloy containing a magnetic element and a non-magnetic element. The first ferromagnetic layer 1 may be composed of multiple layers. The first ferromagnetic layer 1 may be, for example, a CoFeB alloy, a stacked body in which a CoFeB alloy layer is sandwiched between Fe layers, or a stacked body in which a CoFeB alloy layer is sandwiched between CoFe layers. In general, “ferromagnetic” may include “ferrimagnetic”. The first ferromagnetic layer 1 may exhibit ferrimagnetic properties. Alternatively, the first ferromagnetic layer 1 may exhibit ferromagnetic properties that are not ferrimagnetic. For example, a CoFeB alloy exhibits ferromagnetic properties that are not ferrimagnetic.

The first ferromagnetic layer 1 may be an in-plane magnetized film with an easy magnetization axis in the in-plane direction (any direction in the xy plane) or a perpendicular magnetized film with an easy magnetization axis in the direction perpendicular to the film plane (z-axis direction).

The thickness of the first ferromagnetic layer 1 is, for example, 1 nm~5 nm. The thickness of the first ferromagnetic layer 1 is preferably, for example, 1 nm~2 nm. When the first ferromagnetic layer 1 is a perpendicular magnetized film, if the thickness of the first ferromagnetic layer 1 is thin, the effect of perpendicular magnetic anisotropy applied from the layers above and below the first ferromagnetic layer 1 is strengthened, and the perpendicular magnetic anisotropy of the first ferromagnetic layer 1 is enhanced. In other words, if the perpendicular magnetic anisotropy of the first ferromagnetic layer 1 is high, the force that causes the magnetization M1 to return to the z-axis direction is strengthened. On the other hand, if the thickness of the first ferromagnetic layer 1 is large, the effect of applying perpendicular magnetic anisotropy from the layers above and below the first ferromagnetic layer 1 becomes relatively weak, and the perpendicular magnetic anisotropy of the first ferromagnetic layer 1 becomes weak.

If the thickness of the first ferromagnetic layer 1 becomes thin, the volume of the ferromagnetic body becomes small, and if the thickness becomes thick, the volume of the ferromagnetic body becomes large. The responsiveness of the magnetization of the first ferromagnetic layer 1, when external energy is applied thereto, is inversely proportional to the product (KuV) of the magnetic anisotropy (Ku) and the volume (V) of the first ferromagnetic layer 1. In other words, if the product of the magnetic anisotropy and the volume of the first ferromagnetic layer 1 becomes small, the responsiveness to light increases. From this perspective, in order to increase the responsiveness to light, it is preferable to appropriately design the magnetic anisotropy of the first ferromagnetic layer 1 and then reduce the volume of the first ferromagnetic layer 1.

If the thickness of the first ferromagnetic layer 1 is thicker than 2 nm, an insertion layer made of, for example, Mo or W may be provided in the first ferromagnetic layer 1. In other words, the first ferromagnetic layer 1 may be a stacked body in which a ferromagnetic layer, an insertion layer, and a ferromagnetic layer are stacked in the z-axis direction. The perpendicular magnetic anisotropy of the entire first ferromagnetic layer 1 is enhanced by the interface magnetic anisotropy at the interface between the insertion layer and the ferromagnetic layer. The thickness of the insertion layer is, for example, 0.1 nm~1.0 nm.

<Second ferromagnetic layer> The second ferromagnetic layer 2 is a magnetization fixed layer. The magnetization fixed layer is a layer made of a magnetic material whose magnetization state is less likely to change when a certain external energy is applied to it than the magnetization free layer. For example, the magnetization direction of the magnetization fixed layer is less likely to change when a certain external energy is applied to it than the magnetization free layer. In addition, for example, the magnetization of the fixed layer is less likely to change than that of the free layer when a certain external energy is applied thereto. The coercive force of the second ferromagnetic layer 2 is, for example, greater than that of the first ferromagnetic layer 1. The second ferromagnetic layer 2 has an easy magnetization axis in the same direction as the first ferromagnetic layer 1. The second ferromagnetic layer 2 may be an in-plane magnetized film or a perpendicular magnetized film.

The material constituting the second ferromagnetic layer 2 is, for example, the same as that of the first ferromagnetic layer 1. The second ferromagnetic layer 2 may be a multilayer film in which, for example, Co having a thickness of 0.4 nm~1.0 nm and Pt having a thickness of 0.4 nm~1.0 nm are alternately stacked several times. The second ferromagnetic layer 2 may be, for example, a stacked body in which Co having a thickness of 0.4 nm~1.0 nm, Mo having a thickness of 0.1 nm~0.5 nm, a CoFeB alloy having a thickness of 0.3 nm~1.0 nm, and Fe having a thickness of 0.3 nm~1.0 nm are stacked in this order.

<Spacer layer> The spacer layer 3 is a layer disposed between the first ferromagnetic layer 1 and the second ferromagnetic layer 2. The spacer layer 3 may be composed of a layer made of a conductor, an insulator, or a semiconductor, or a layer containing a current-carrying point made of a conductor in an insulator. The spacer layer 3 is, for example, a non-magnetic layer. The thickness of the spacer layer 3 can be adjusted according to the orientation of the magnetization of the first ferromagnetic layer 1 and the magnetization of the second ferromagnetic layer 2 in the initial state described later.

When the spacer layer 3 is composed of an insulating material, a material containing aluminum oxide, magnesium oxide, titanium oxide, silicon oxide, or the like can be used as the material of the spacer layer 3. In addition, these insulating materials may contain elements such as Al, B, Si, Mg, or magnetic elements such as Co, Fe, and Ni. By adjusting the thickness of the spacer layer 3 so that a high TMR effect would occur between the first ferromagnetic layer 1 and the second ferromagnetic layer 2, a high magnetoresistance change rate can be obtained. In order to efficiently utilize the TMR effect, the thickness of the spacer layer 3 may be about 0.5 nm~5.0 nm, or about 1.0 nm~2.5 nm.

When the spacer layer 3 is made of a nonmagnetic conductive material, conductive materials such as Cu, Ag, Au, or Ru can be used. In order to efficiently utilize the GMR effect, the thickness of the spacer layer 3 may be about 0.5 nm~5.0 nm, or about 2.0 nm~3.0 nm.

When the spacer layer 3 is made of a nonmagnetic semiconductor material, materials such as zinc oxide, indium oxide, tin oxide, germanium oxide, gallium oxide, or indium tin oxide (ITO) can be used. In this case, the thickness of the spacer layer 3 may be about 1.0 nm~4.0 nm.

When a layer including a current-carrying point formed by a conductor in a nonmagnetic insulator is applied as the spacer layer 3, a structure including a current-carrying point formed by a nonmagnetic conductor such as Cu, Au, or Al in a nonmagnetic insulator made of aluminum oxide or magnesium oxide may be used. The conductor may also be made of magnetic elements such as Co, Fe, or Ni. In this case, the thickness of the spacer layer 3 may be about 1.0 nm~2.5 nm. The current-carrying point is, for example, a columnar body with a diameter of 1 nm~5 nm when viewed from a direction perpendicular to the film surface.

<Cap layer> The cap layer 4 is provided between the first ferromagnetic layer 1 and the first electrode 11. The cap layer 4 may include a perpendicular magnetization induction layer (not shown) stacked on the first ferromagnetic layer 1 and in contact with the first ferromagnetic layer 1. The cap layer 4 prevents damage to the lower layer during the manufacturing process and enhances the crystallinity of the lower layer during annealing. The thickness of the cap layer 4 is, for example, 10 nm or less so that the first ferromagnetic layer 1 is irradiated with sufficient light.

<Insulating layer> The insulating layer 16 is provided between the first electrode 11 and the second electrode 12 or the cap layer 13, and is formed to cover the periphery of the magnetic element 10. The insulating layer 16 is, for example, an oxide, nitride, or oxynitride of Si, Al, or Mg. The insulating layer 16 is, for example, silicon oxide (SiOx), silicon nitride (SiNx), silicon carbide (SiC), chromium nitride, silicon carbonitride (SiCN), silicon oxynitride (SiON), aluminum oxide (Al2O3), zirconium oxide (ZrOx), etc.

<First electrode> The first electrode 11 is disposed, for example, on the upper side of the magnetic element 10. Incident light is irradiated from the first electrode 11 side to the magnetic element 10, and is irradiated to at least the first ferromagnetic layer 1. The first electrode 11 is made of a material having electrical conductivity. The first electrode 11 is, for example, a transparent electrode that is transparent to light in the wavelength range used. The first electrode 11 preferably transmits, for example, 80% or more of light in the wavelength range used. The first electrode 11 is, for example, an oxide such as indium tin oxide (ITO), indium zinc oxide (IZO), zinc oxide (ZnO), or indium gallium zinc oxide (IGZO). The first electrode 11 is, for example, an ITO transparent electrode with a thickness of 50 nm in the z-axis direction. The first electrode 11 may be configured to have a plurality of columnar metals in the transparent electrode material of these oxides.

It is not essential to use the above-mentioned transparent electrode material for the first electrode 11. A thin metal material such as Au, Cu, or Al may be used to allow the irradiated light to reach the first ferromagnetic layer 1. When a metal is used as the material for the first electrode 11, the thickness of the first electrode 11 is, for example, 3 nm ~10 nm. The first electrode 11 may also have an anti-reflection film on the irradiation surface to which light is irradiated.

<Second electrode> The second electrode 12 is made of a material having electrical conductivity. The second electrode 12 is made of a metal such as Cu, Al, or Au. Ta or Ti may be stacked above and below these metals. A stacked film of Cu and Ta, a stacked film of Ta, Cu, and Ti, or a stacked film of Ta, Cu, and TaN may also be used. TiN or TaN may also be used as the second electrode 12. The second electrode 12 has a multi-layer structure in which, for example, a Ta layer, a Ru layer, and a Ta layer are stacked, and the thickness in the z-axis direction is, for example, 70 nm.

The second electrode 12 may be transparent to the light irradiated to the magnetic element 10. Similarly to the first electrode 11, the second electrode 12 may be made of an oxide transparent electrode material such as indium tin oxide (ITO), indium zinc oxide (IZO), zinc oxide (ZnO), or indium gallium zinc oxide (IGZO). Even when light is irradiated from the first electrode 11, the light may reach the second electrode 12 depending on the intensity of the light. In this case, since the second electrode 12 is made of an oxide transparent electrode material, the reflection of light at the interface between the second electrode 12 and the layer in contact with it can be suppressed compared to when the second electrode 12 is made of a metal.

(Regarding the shape of the magnetic element) Returning to FIGS. 1 and 2, the magnetic element 10 as a light detection portion has a rectangular shape with different long and short sides when viewed in a plan view from the first direction (i.e., the z-axis direction), which is the direction of light incidence. Specifically, in FIG. 1, the length Lx of the magnetic element 10 in the x-axis direction is different from the length Ly in the y-axis direction (Lx ≠Ly). This configuration can provide polarization selectivity and/or wavelength selectivity. More specifically, by making the plan view shape of the MTJ pillar, for example, of the magnetic element 10 rectangular, it is possible to provide polarization selectivity to the light absorption rate (sensitivity). In addition, by adjusting the dimensions of the rectangle, it is possible to suppress the reflectivity and selectively to improve the sensitivity in a specific wavelength range.

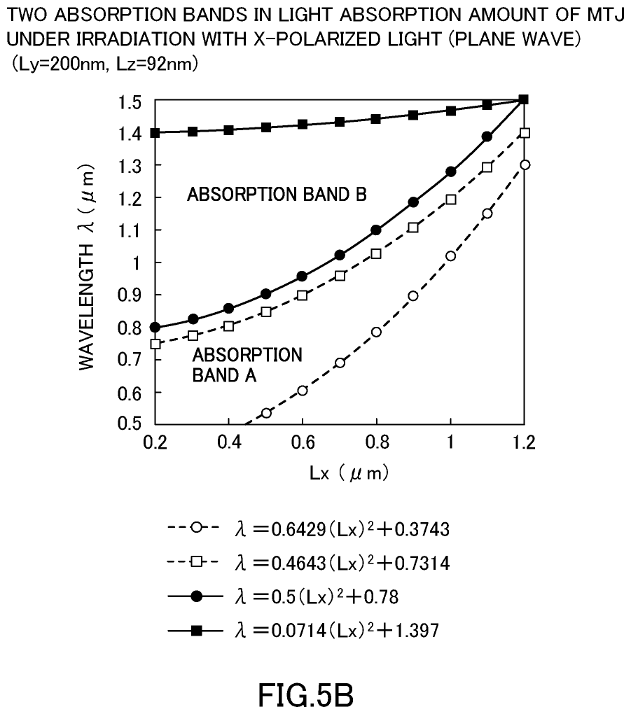

FIG. 4 shows results of a simulation of the dependence of the light absorption amount (arbitrary units) of the MTJ pillar on the length Lx of the magnetic element 10 in the x-axis direction and the wavelength λ of the incident light L. The magnetic element 10 was an MTJ pillar. The length Ly of the magnetic element 10 in the y-axis direction was set to Ly=200 nm, the thickness Lz of the magnetic element 10 in the z-axis direction was set to Lz=92 nm, and the case where x-polarized light (plane wave) was irradiated was assumed. The x-polarized light is light polarized in the x-axis direction (see FIG. 1). From FIG. 4, it can be seen that there are two absorption bands in which the wavelength λ increases as the length Lx increases, and that the light absorption amount of the MTJ pillar is high in these two absorption bands. In other words, by changing the length Lx under the condition that the length Lx ≠the length Ly, it is possible to selectively improve the absorption rate of x-polarized light of a specific wavelength. The same is true for y-polarized light, and by changing the length Ly under the condition that the length Ly ≠the length Lx, it is possible to selectively improve the absorption rate of y-polarized light of a specific wavelength.

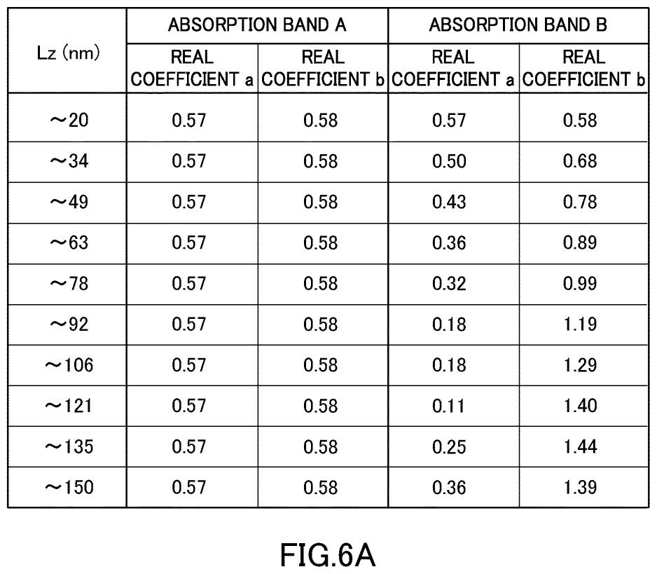

In FIG. 5A, in order to identify the two absorption bands in FIG. 4, the center lines along each absorption band are plotted on a graph with the horizontal axis being length Lx (μm) and the vertical axis being wavelength λ (μm). As shown in FIG. 5A, the absorption band A is expressed as:

$$λ = 0.571 {( L x )}^{2} + 0.577 ,$$

and
the absorption band B is expressed as:

$$λ = 0.179 {( L x )}^{2} + 1.19 .$$

In FIG. 5B, in order to identify the two absorption bands in FIG. 4, the boundary lines of each absorption band are plotted on a graph with the horizontal axis being length Lx (μm) and the vertical axis being wavelength λ (μm). As shown in FIG. 5B, the absorption band A is expressed as:

$$0.642 {( L x )}^{2} + 0.374 ≦ λ ≦ 0.464 {( L x )}^{2} + 0.731 ,$$

and
the absorption band B is expressed as:

$$0.5 {( L x )}^{2} + 0.78 ≦ λ ≦ 0.071 {( L x )}^{2} + 1.39 and 0.2 ≦ Lx ≦ 1.2 .$$

In this way, the center lines of the two absorption bands are fitted by a quadratic function of length Lx:

$$λ = {a ( L x )}^{2} + b .$$

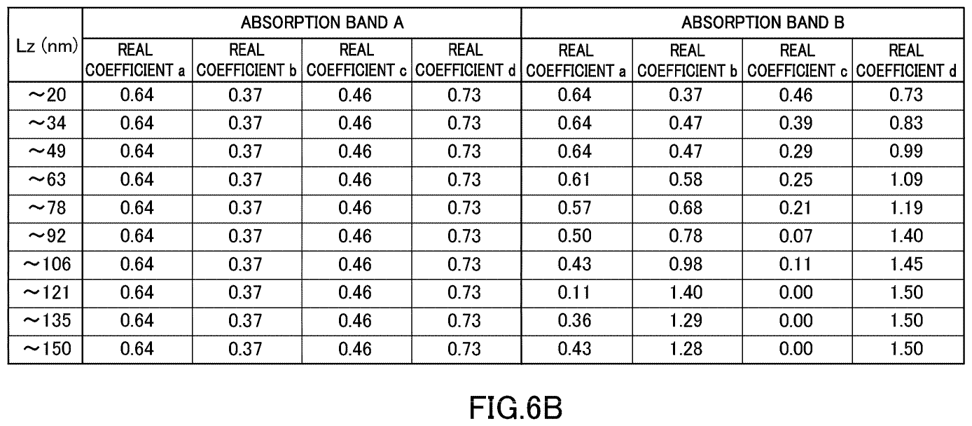

Here, λ is the wavelength of the incident light L, Lx is the length of the polarization direction (x-axis direction) of the magnetic element 10, and a and b are real coefficients. Here, the real coefficients a and b depend on the thickness Lz of the magnetic element 10. FIG. 6A shows a table of real coefficients a and b of the function:

$$λ = {a ( L x )}^{2} + b ,$$

which fits the center lines in the absorption bands A and B when the thickness Lz of the magnetic element 10 is between 20 nm and 150 nm. The position of the center line of the absorption band A does not depend on the thickness Lz of the magnetic element 10, and the position of the center line of the absorption band B shifts to the longer wavelength side as the thickness Lz of the magnetic element 10 increases.

Similarly, the area occupied by the two absorption bands is expressed by a quadratic inequality of the length Lx:

$$a {L}^{2} + b ≦ λ ≦ c {L}^{2} + d ( a , b , c , d are real coefficients ) .$$

Here, λ is the wavelength of the incident light L, Lx is the length of the polarization direction (x-axis direction) of the magnetic element 10, and a, b, c, d are real coefficients. Here, the real coefficients a, b, c, d depend on the thickness Lz of the magnetic element 10. FIG. 6B is a table showing the real coefficients a, b, c, and d of the quadratic inequality:

$$a {L}^{2} + b ≦ λ ≦ c {L}^{2} + d ,$$

which expresses the absorption band occupancy area in the absorption band A and the absorption band B when the thickness Lz of the magnetic element 10 is between 20 nm and 150 nm.

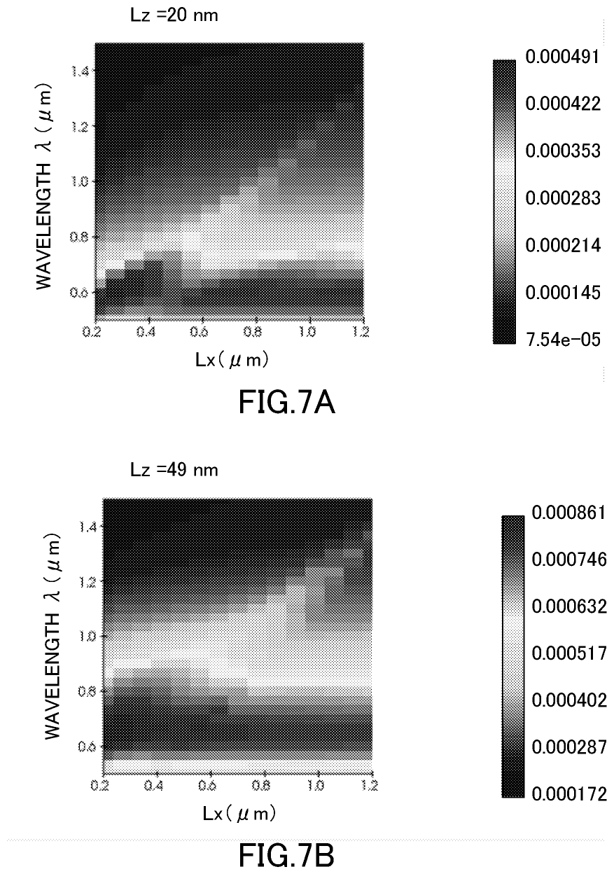

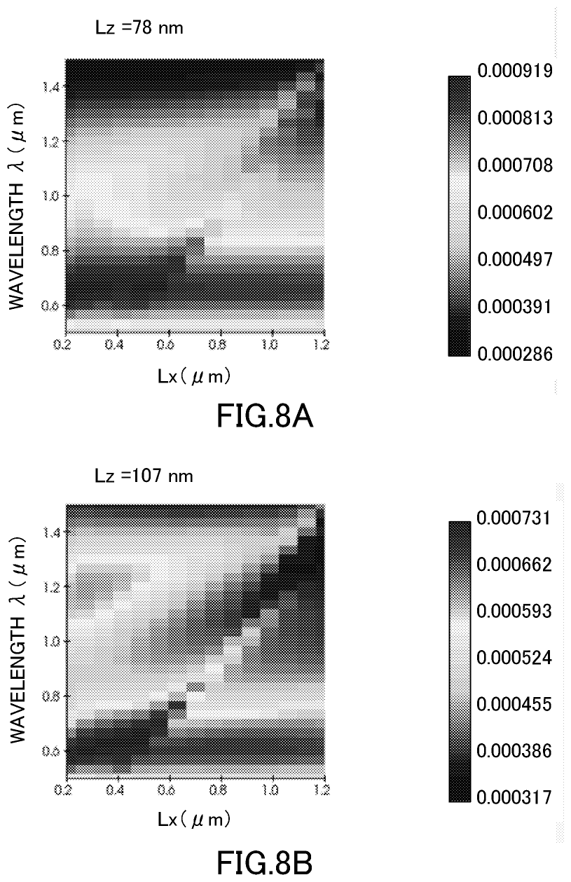

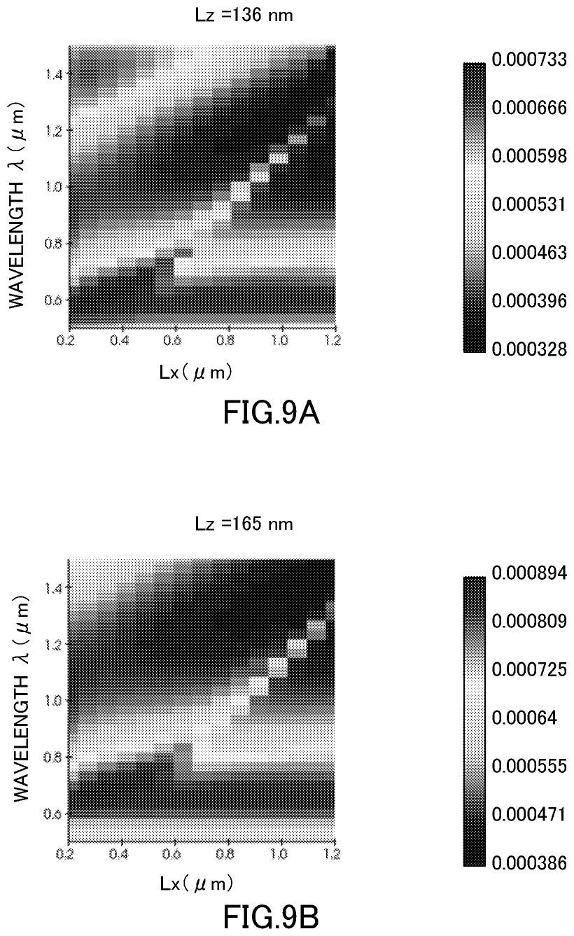

FIGS. 7A, 7B, 8A, 8B, 9A and 9B show the results of simulating the amount of light absorption (arbitrary units) of the MTJ pillar, with the horizontal axis representing the length Lx of the MTJ pillar and the vertical axis representing the wavelength λ of the incident light L. FIG. 7A shows the case where the thickness of the MTJ pillar is Lz=20 nm, FIG. 7B shows the case where Lz=49 nm, FIG. 8A shows the case where Lz=78 nm, FIG. 8B shows the case where Lz=107 nm, FIG. 9A shows the case where Lz=136 nm, and FIG. 9B shows the case where Lz=165 nm. From FIGS. 7, 8, and 9, it can be seen that there are one or two absorption bands, the range of which can be described using a quadratic equation or quadratic inequality in Lx, respectively.

Also, from FIGS. 7A, 7B, 8A, 8B, 9A and 9B, it can be seen that when the thickness Lz of the magnetic element 10 changes, the coefficients a and b of the quadratic function of the length Lx that specifies the absorption band change. In other words, the absorption condition depends on Lz. Therefore, in the light detection element 100 according to this embodiment, the length Lx of the magnetic element 10 in the x-axis direction (polarization direction) can be appropriately set based on the thickness Lz of the magnetic element 10 in the z-axis direction. Also, although the x-polarized light, whose polarization direction is the x-axis direction, has been described above, the same applies to the y-polarized light, whose polarization direction is the y-axis direction.

(Manufacturing process) The light detection element 100 is obtained by sequentially fabricating the second electrode 12, the magnetic element 10, the insulating layer 16, and the first electrode 11.

The magnetic element 10 is fabricated through a process of stacking each layer, an annealing process, a processing process, etc. First, the cap layer 13, the second ferromagnetic layer 2, the spacer layer 3, the first ferromagnetic layer 1, and the cap layer 4 are stacked in this order on the second electrode 12. Each layer is formed by, for example, sputtering.

Then, the stacked film is annealed. The annealing temperature is, for example, 250° C.~400° C. Then, the stacked film is processed into a columnar stacked body 15 by, for example, photolithography and etching. The stacked body 15 may be in the shape of a mesa, a cylinder, a prism, a truncated cone, a truncated pyramid, or the like, either as a whole or in each layer. The shortest width of the stacked body 15 as viewed from the z-axis direction is, for example, 10 nm~1000 nm.

Then, an insulating layer 16 is formed so as to cover the side surface of the stacked body 15. The insulating layer 16 may be stacked multiple times. Next, the upper surface of the cap layer 4 is exposed from the insulating layer 16 by, for example, chemical mechanical polishing, and a first electrode layer is formed on the cap layer 4 and the insulating layer 16 by sputtering. The first electrode layer is processed, for example, by photolithography and etching, into a columnar or plate-shaped first electrode 11, such as a cylindrical shape, a prismatic shape, a truncated cone shape, or a truncated pyramid shape.

An insulating layer may be formed on the first electrode 11, and a lens such as a metalens may be formed on the insulating layer. A light detection element 100 can be obtained by the above process. In this manner, the second electrode 12, the magnetic element 10, and the first electrode 11 can be successively formed by a vacuum film formation process in the manufacture of the light detection element 100,.

(Explanation of Operation) Next, the operation of the light detection element 100 according to an embodiment will be described.

As shown in FIG. 2, the incident light L on the light detection element 100 passes through the transparent first electrode 11 and is irradiated onto the magnetic element 10, particularly the first ferromagnetic layer 1. When the intensity of the light irradiated to the first ferromagnetic layer 1 changes, the state of the magnetization M1 of the first ferromagnetic layer 1 changes. The state of the magnetization M1 is, for example, the tilt angle of the magnetization M1 with respect to the z-axis direction, the magnitude of the magnetization M1, etc.

For example, when the intensity of the light irradiated to the first ferromagnetic layer 1 increases, the magnetization M1 of the first ferromagnetic layer 1 tilts from its initial state due to the external energy caused by the light irradiation. The angle between the direction of the magnetization M1 of the first ferromagnetic layer 1 with light irradiation to the first ferromagnetic layer 1 and the direction of the magnetization M1 without light irradiation to the first ferromagnetic layer 1 can be, for example, greater than 0° and less than 90°. Alternatively, for example, when the intensity of the light irradiated to the first ferromagnetic layer 1 increases, the magnitude of the magnetization M1 decreases.

When the state of the magnetization M1 of the first ferromagnetic layer 1 changes, the resistance value of the magnetic element 10 in the z-axis direction changes due to the magnetoresistance effect. When a constant current (sense current) is passed through the magnetic element 10 in the positive or negative direction of the z-axis using the first electrode 11 and the second electrode 12, an output voltage is obtained from the magnetic element 10. In other words, when the state of the magnetization M1 of the first ferromagnetic layer 1 changes, the output voltage from the magnetic element 10 also changes.

The intensity of the light irradiated to the first ferromagnetic layer 1, for example, may take two values a first intensity and a second intensity. The first intensity may be the case where the intensity of the light irradiated to the first ferromagnetic layer 1 is zero. The intensity of the light irradiated to the first ferromagnetic layer 1 may take multiple values or may change analogically. When the intensity of the incident light is multi-valued, the output voltage of the magnetic element 10 can also be multi-valued, and when the intensity of the light changes in an analog manner, the output voltage of the magnetic element 10 can also be changed in an analog manner. The difference in these output voltages (resistance values) can be read out from the light detection element 100 as binary, multi-valued, or analog data.

In a state (referred to as the “initial state”) where the first ferromagnetic layer 1 is irradiated with light of a first intensity (zero intensity is also acceptable), the magnetization M1 of the first ferromagnetic layer 1 and the magnetization M2 of the second ferromagnetic layer 2 may be parallel or anti-parallel, or the magnetization M1 and the magnetization M2 may be perpendicular to each other.

When the magnetization M1 and the magnetization M2 are parallel in the initial state, for example, a sense current is passed from the first ferromagnetic layer 1 to the second ferromagnetic layer 2. By passing the sense current in this direction, a spin transfer torque in the same direction as the magnetization M2 of the second ferromagnetic layer 2 acts on the magnetization M1 of the first ferromagnetic layer 1, and the magnetization M1 and the magnetization M2 become parallel in the initial state. In addition, by passing the sense current in this direction, it is possible to prevent the magnetization M1 of the first ferromagnetic layer 1 from being reversed during operation.

When the magnetization M1 and the magnetization M2 are antiparallel in the initial state, it is preferable to pass the sense current from the second ferromagnetic layer 2 toward the first ferromagnetic layer 1. By passing the sense current in this direction, a spin transfer torque in the opposite direction to the magnetization M2 of the second ferromagnetic layer 2 acts on the magnetization M1 of the first ferromagnetic layer 1, and the magnetization M1 and the magnetization M2 become antiparallel in the initial state.

When the intensity of the light irradiated to the first ferromagnetic layer 1 returns to the first intensity, a spin transfer torque is applied by the sense current, or the state of the magnetization M1 of the first ferromagnetic layer 1 returns to the original state by the action of magnetic anisotropy, and the magnetic element 10 returns to the initial state.

In this way, the light detection element 100 according to an embodiment can convert the change in the intensity of the irradiated light into a change in the output voltage from the magnetic element 10. In other words, the light detection element 100 can convert light into an electrical signal.

As described above, the light detection element 100 according to embodiments of the present disclosure can have polarization selectivity and/or wavelength selectivity by having the magnetic element 10 have a rectangular shape with different lengths of long and short sides in a plan view seen from the z-axis direction, which is the direction of light incidence.

[Application Example] The light detection element 100 of the above embodiments can be applied to an optical sensor such as an image sensor in which a plurality of light detection elements are arranged one-dimensionally or two-dimensionally. Such an optical sensor can be used in information terminal devices such as smartphones, tablets, personal computers, and digital cameras.

The light detection element 100 of the first embodiment can be applied to a photoelectric conversion element of a receiver provided in a transmitter/receiver that transmits and receives optical signals such as laser light in a communication system in which a plurality of transmitter/receivers are connected by optical fibers. The above communication system may be, for example, a communication system that performs short-or medium-distance communication such as within a data center or between data centers, or long-distance communication such as between cities. The transmitter/receiver is installed, for example, in a data center.

The above communication system may be, for example, a communication system that performs wireless transmission and reception of optical signals such as near-infrared light between mobile terminals such as smartphones and tablets. Furthermore, the above-mentioned communication system may be a communication system for wirelessly transmitting and receiving optical signals, such as near-infrared light, between a mobile terminal and an information processing device, such as a personal computer.

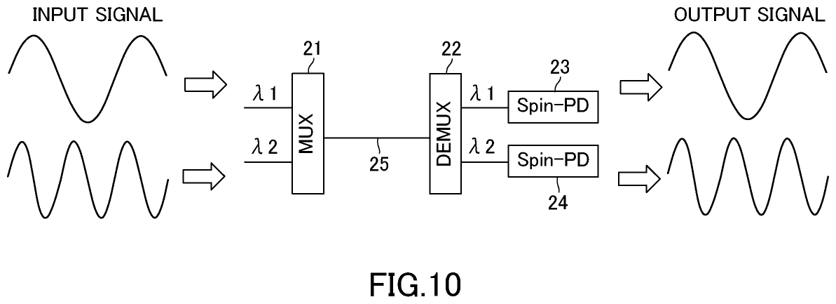

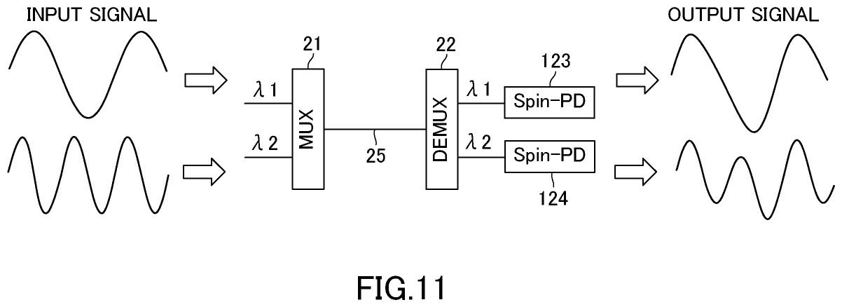

FIG. 10 shows the relationship between input and output signals when the light detection element 100 according to an embodiment is applied to a receiver for optical communication using a multiplexing method. A signal with a wavelength λ1 and a signal with a wavelength λ2 are multiplexed by a multiplexer 21 and sent to an optical fiber 25. The multiplexed signal sent through the optical fiber 25 is demultiplexed by a demultiplexer 22 into a signal with a wavelength λ1 and a signal with a wavelength λ2, which are detected by spin photodetectors 23 and 24, respectively. The light detection element 100 according to an embodiment can be used as the spin photodetectors 23 and 24. If a light detection element 100 with polarization and wavelength selectivity is used, the output signals will not be mixed even if crosstalk of optical signals occurs in the demultiplexer 22.

As described above, the light detection portion of the light detection element according to the present disclosure can effectively function as a magnetoresistance effect element such as an MTJ (Magnetic Tunnel Junction) element. Specifically, the magnetization state of the first ferromagnetic layer changes when irradiated with light, and the resistance value of the light detection portion changes with the change in the magnetization state, so that the irradiated light can be detected as an electrical signal. Therefore, a light detection element having polarization selectivity and/or wavelength selectivity can be provided.

Since the light detection portion of one of the aspects of the present disclosure has a rectangular shape with different lengths of long and short sides when viewed from the direction of light incidence, the light detection portion can have the effect of polarization selectivity and/or wavelength selectivity and can be applied to photodetection elements in general.

Although the disclosure has been described with respect to only a limited number of embodiments, those skilled in the art, having benefit of this disclosure, will appreciate that various other embodiments may be devised without departing from the spirit and scope of the present disclosure. Accordingly, the technical scope of the disclosed subject matter should be limited only by the attached claims.

### Description of Reference Numerals and Signs

1 First ferromagnetic layer
2 Second ferromagnetic layer
3 Spacer layer
4, 13 Cap layer
10 Magnetic element (Light detection portion)
11 First electrode
12 Second electrode
15 Stacked body
16 Insulating layer
21 Multiplexer
22 Demultiplexer
23, 24 Spin photodetector
25 Optical fiber
123, 124 Spin photodetector detector
100 Light detection element
M1, M2 Magnetization

What is claimed is:

1. A light detection element comprising:
a light detection portion for detecting light;
a first electrode having optical transparency; and
a second electrode;
wherein:
the light detection portion is located between the first electrode and the second electrode; and
the light detection portion has a rectangular shape with different lengths of long side and short side when viewed in a plan view from a first direction, which is a direction of incidence of the light.

2. The light detection element according to claim 1, wherein a relationship represented by (λ=a L²+b) holds, where:
a and b are real coefficients;
λ is a wavelength of the light; and
L is a length of the light detection portion in a second direction which is a polarization direction of the light perpendicular to the first direction.

3. The light detection element according to claim 2, wherein the length L of the light detection element in the second direction is 20 nm or more and 150 nm or less, and is set based on the thickness of the light detection element in the first direction.

4. The light detection element according to claim 1, wherein a relationship represented by (a L²+b≤λ≤c L²+d) holds, where:
a, b, c and d are real coefficients;
λ is a wavelength of the light; and
L is a length of the light detection portion in a second direction which is a polarization direction of the light perpendicular to the first direction.

5. The light detection element according to claim 1, wherein the light detection portion includes a first ferromagnetic layer, a second ferromagnetic layer, and a spacer layer sandwiched between the first ferromagnetic layer and the second ferromagnetic layer.

6. The light detection element according to claim 5, wherein coercive force of the second ferromagnetic layer is greater than coercive force of the first ferromagnetic layer.

7. The light detection element according to claim 5, wherein the second ferromagnetic layer has an easy magnetization axis along a direction of an easy magnetization axis of the first ferromagnetic layer.

8. The light detection element according to claim 5, wherein the first ferromagnetic layer includes either one of Co, Fe, and Ni.

9. The light detection element according to claim 8, wherein the first ferro magnetic layer includes either one of B, Mg, Hf, and Gd.

10. The light detection element according to claim 9, wherein the first ferromagnetic layer includes either one of a CoFeB alloy, a stacked body in which a CoFeB alloy layer is sandwiched between Fe layers, and a stacked body in which a CoFeB alloy layer is sandwiched between CoFe layers.

11. The light detection element according to claim 5, wherein the first ferromagnetic layer has an insertion layer made of either one of Mo and W.

12. The light detection element according to claim 5, wherein a thickness of the first ferromagnetic layer has 1 nm~5 nm.

13. The light detection element according to claim 5, wherein the second ferromagnetic layer includes either one of Co, Fe, and Ni.

14. The light detection element according to claim 13, wherein the first ferromagnetic layer includes either one of B, Mg, Hf, and Gd.

15. The light detection element according to claim 5, wherein the second ferromagnetic layer has a multilayer film in which Co having a thickness of 0.4 nm~1.0 nm and Pt having a thickness of 0.4 nm~1.0 nm are alternately stacked.

16. The light detection element according to claim 5, wherein the second ferromagnetic layer has a stacked body in which Co having a thickness of 0.4 nm~1.0 nm, Mo having a thickness of 0.1 nm~0.5 nm, a CoFeB alloy having a thickness of 0.3 nm~1.0 nm, and Fe having a thickness of 0.3 nm~1.0 nm are sequentially stacked.

17. The light detection element according to claim 5, wherein:
the spacer layer has an insulating material including either one of aluminum oxide, magnesium oxide, titanium oxide, and silicon oxide; and
the spacer layer has a current-carrying point formed by a nonmagnetic element including either one of Cu, Au, and Al or a magnetic element including either one of Co, Fe, and Ni.

18. The light detection element according to claim 5, wherein the spacer layer has a 0.5 nm~5.0 nm thickness of a nonmagnetic conductive material including either one of Cu, Ag, Au, and Ru.

19. The light detection element according to claim 5, wherein the spacer layer has a 1.0 nm~4.0 nm thickness of a nonmagnetic semiconductor material including either one of zinc oxide, indium oxide, tin oxide, germanium oxide, gallium oxide, and indium tin oxide (ITO).

20. The information terminal device comprising a light detection element according to claim 1.
